(19) United States
(12) Patent Application Publication
(10) Pub. No.: US 2022/0039431 A1
(43) Pub. Date: Feb. 10, 2022

(54) SYSTEM AND METHOD FOR EXTRACTING A PROTEIN FOOD PRODUCT

(71) Applicant: Australian Plant Proteins Pty Ltd, Melbourne Victoria (AU)

(72) Inventors: Phillip McFarlane, Hampton, Victoria (AU); Brendan McKeegan, Jan Juc, Victoria (AU); Christa Lingham, Rupanyup, Victoria (AU); Rod Lingham, Rupanyup, Victoria (AU)

(73) Assignee: Australian Plant Proteins Pty Ltd, Melbourne Victoria (AU)

(21) Appl. No.: 17/275,150

(22) PCT Filed: Mar. 11, 2019
(86) PCT No.: PCT/AU2019/000107

§ 371 Date: Mar. 10, 2021

(30) Foreign Application Priority Data
Sep. 11, 2018 (AU) 2018903408

(51) Int. Cl. A23L 2/39; A23L 2/66; A23L 33/185; A23P 10/40; A23L 11/00; A23J 1/14

(52) U.S. Cl. CPC A23L 2/39; A23L 2/66; A23J 1/14; A23P 10/40; A23L 11/05; A23L 33/185

(57) ABSTRACT

Disclosed herein are systems and methods of extracting a high protein food product from legumes comprising: milling a supply of legumes to form a fine powder; hydrating the fine powder to form a liquid slurry; separating solids from the liquid slurry to form a milk-like fluid; pasteurising said milk-like fluid to remove unwanted organisms therefrom; filtrating said pasteurised milk-like fluid to remove permeates therefrom to form a substantially liquid product; and removing most of the moisture from the substantially liquid product to generate a high protein food product in the form of a powder.

### RELATED APPLICATION(S)

The present application claims priority from Australian Provisional Patent Application No. 2018903408, filed on 11 Sep. 2018, the entire content of which is incorporated herein by reference.

### FIELD OF INVENTION

The present invention relates generally to a system and method for extracting a protein food product from legumes, such as the bean variety known as Vicia faba, often referred to as the faba or broad bean.

### BACKGROUND OF THE INVENTION

Protein is a nutrient essential to body growth and makes up about 15% of a human's body weight. Protein is present in every cell in the human body and the body uses protein to build and repair tissue and to make enzymes, hormones and other important body chemicals. However, whilst the body uses protein it does not store protein as it does with fat and carbohydrates. Hence, protein must be regularly supplied to the body to ensure that there is sufficient protein available to cater for the body's needs and enable the body to recover quickly after exercise, reduce muscle loss and maintain a healthy body weight.

Protein can be obtained naturally from a variety of sources, such as meat, milk, fish, eggs and legumes. For many, a healthy diet can provide their daily protein requirements. However, for an increasing number for people with different dietary requirements, such as vegetarians or vegans and people with food allergies, they may not be in apposition to draw protein from conventional sources and may require supplements to boost their protein intake. This may be the case for many high performance athletes, body builders and the like, who require a higher protein intake than normal due to the amount of exercise their body is undertaking.

Protein supplements may traditionally come from whey, which is the liquid that remains after milk has been curdled and strained. Whey may be provided in a powder form and is used by many body builders to promote lean muscle mass, but is not suitable for vegans or those with lactose intolerance. Soy protein is another form of protein supplement which comes from soybeans and which may be provided in the form of a soy milk or powder. However soy protein has a particular flavour or taste which many do not find pleasant when mixed with their foods or when taken as a separate supplement. When mixed with other foods, the soy protein may overwhelm the taste of the other foods, thereby minimising the enjoyment of those foods. Peas are also often used as a source of supplementary protein and also suffer from a similar problem to soy beans in that they have an overpowering taste and coloured texture that makes them difficult to use with other fruits and vegetables in a shake or the like.

Thus, there is a need to provide an alternative source of protein that can be provided in a powdered form that has a neutral flavour and colour profile to be used with any number of other food products and which is high in protein.

The above references to and descriptions of prior proposals or products are not intended to be, and are not to be construed as, statements or admissions of common general knowledge in the art. In particular, the following prior art discussion does not relate to what is commonly or well known by the person skilled in the art, but assists in the understanding of the inventive step of the present invention of which the identification of pertinent prior art proposals is but one part.

### STATEMENT OF INVENTION

According to a first aspect, there is provided a method of extracting a high protein food product from legumes comprising:

milling a supply of legumes to form a fine powder;

hydrating the fine powder to form a liquid slurry;

separating solids from the liquid slurry to form a milk-like fluid;

pasteurising said milk-like fluid to remove unwanted organisms therefrom;

filtrating said pasteurised milk-like fluid to remove permeates therefrom to form a substantially liquid product; and

removing at least 94% of moisture from the substantially liquid product to generate a high protein food product in the form of a powder.

The step of milling the supply of legumes may comprises screening the beans to remove oversized beans and material from the process. The beans may be passed to a mill for grinding into a fine powder. The size of the fine powder is no greater than 300 microns.

The step of hydrating the fine powder may comprise mixing the fine powder with water at a temperature of between 40-45°. The step of hydrating the fine powder may further comprises further mixing the water and the fine powder with 10% NaOH so as to adjust the pH level of the resultant mixture to around pH 9.3. The step of hydrating the fine powder may comprise creating the liquid slurry to have a powder to liquid ration of around 1:10.

The step of separating solids from the liquid slurry to form a milk-like fluid may comprise delivering the liquid slurry to a decanter for an initial period of time. The decanter separates any solids present in the slurry and collects the solids in bins for removal. This step may further comprises passing the mixture through a clarifier following decanting.

The step of filtrating said pasteurised milk-like fluid to remove permeates therefrom to form a substantially liquid product may comprise passing the pasteurised milk-like fluid through an ultrafiltration unit having multiple membrane. The multiple membranes of the ultrafiltration unit may have different sized pores to provide staged separation of permeates from the fluid.

According to another aspect of the present invention, there is disclosed a system for extracting a high protein food product from legumes in accordance with the method of the first aspect.

According to another aspect of the present invention, there is disclosed a powdered food product produced by the system or method as described above.

Preferably the protein content of the powdered food product comprises at least 80% on a dry weight basis, more preferably at least 85% on a dry weight basis. The sodium content of the of the powdered food product is less than 500 mg/100 g, preferably less than 250 mg/100 g.

In a preferred embodiment, the powdered food product has a solubility of at least 75%, preferably at least 85%.

In a preferred embodiment, the powdered food product has a carbohydrate content of less than 5 g/100 g, preferably less than 3 g/100 g, sugar content of less than 1.5 g per 100 g, preferably less than 1 g/100 g.

### BRIEF DESCRIPTION OF THE DRAWINGS

The invention may be better understood from the following non-limiting description of preferred embodiments, in which:

FIG. 1 is a diagrammatical representation of the milling and hydrating stages of the method in accordance with an embodiment of the present invention;

FIG. 2 is a diagrammatical representation of the separating and pasteurisation stages of the method in accordance with an embodiment of the present invention;

FIG. 3 is a diagrammatical representation of the filtration stage of the method in accordance with an embodiment of the present invention;

FIG. 4 is a diagrammatical representation of the drying and packaging stages of the method in accordance with an embodiment of the present invention;

FIG. 5 is a flow chart depicting how the method of the present invention is conducted from steps A to G;

FIG. 6 is a flow chart depicting more specifically the milling step (A) of FIG. 5;

FIG. 7 is a flow chart depicting more specifically the hydrating step (B) of FIG. 5;

FIG. 8 is a flow chart depicting more specifically the separation step (C) of FIG. 5;

FIG. 9 is a flow chart depicting more specifically the filtration step (D) of FIG. 5;

FIG. 10 is a flow chart depicting more specifically the drying step (E) of FIG. 5; and

FIG. 11 is a flow chart depicting more specifically the packing step (F) of FIG. 5.

### DETAILED DESCRIPTION OF THE DRAWINGS

Preferred features of the present invention will now be described with particular reference to the accompanying drawings. However, it is to be understood that the features illustrated in and described with reference to the drawings are not to be construed as limiting on the scope of the invention.

As alluded to previously, peas, soy beans and the like have long been used to extract protein therefrom in a powdered form for use as a food additive to supplement protein intake. In such situations, dehulled legumes are typically formed into a powder through an appropriate milling process and the resultant powder is sieved in order to separate the fine particles from the larger particles.

Wet extraction processes have also been proposed whereby the legumes have been soaked in a solution for a predetermined period of time on the basis that the protein is quite soluble at alkaline pH values and has low solubility at more acidic vales (˜pH 4.5).

Other combined methods and systems have been proposed which seek to initially grind the material into a powder and to then add water so as to create a slurry which can then undergo fractionation and ultrasound treatments to extract the desired end product that is rich in protein.

The present system and method is an improvement over existing systems and minimises the use of water in the system whilst maximising the protein content present in the end powder product. The system and method of the present invention is described below.

It will be appreciated that the system and method of the present invention will be described below in relation to its application for extracting a high protein powder product from legumes, such as non-genetically modified Faba Beans. It will be appreciated that the system and method of the present invention may be equally applied in relation to the extraction of high protein powder from other raw sources, as will be appreciated by those skilled in the art.

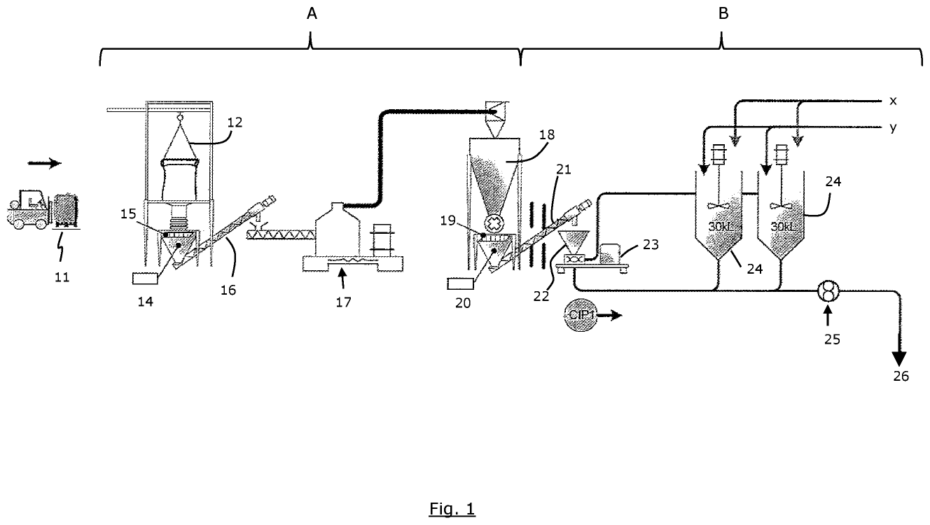

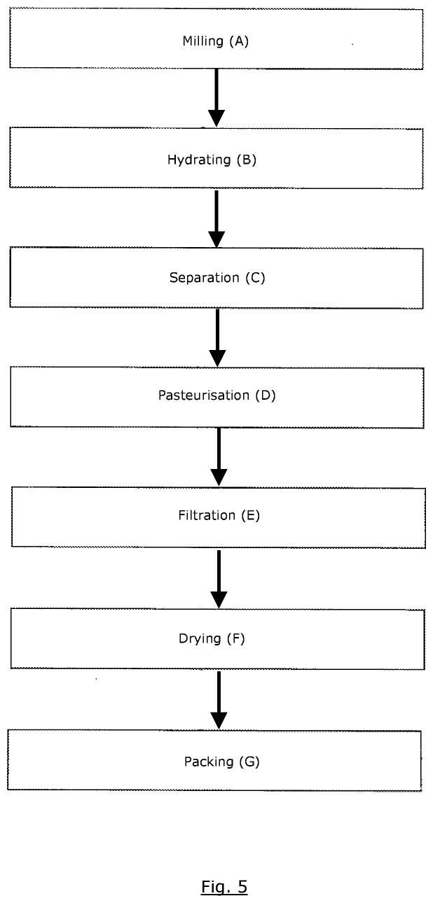

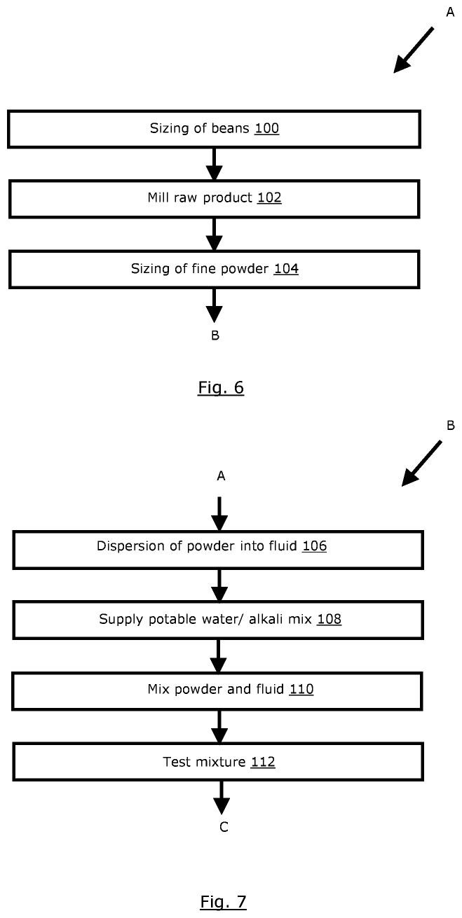

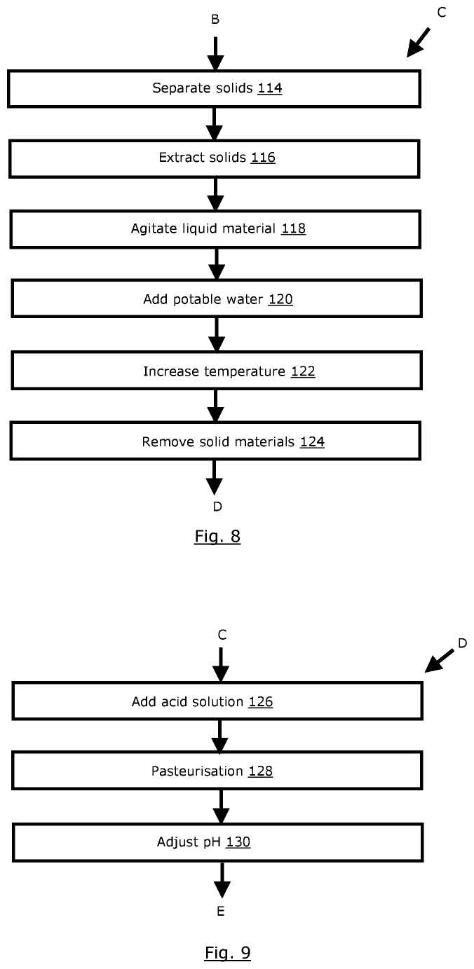

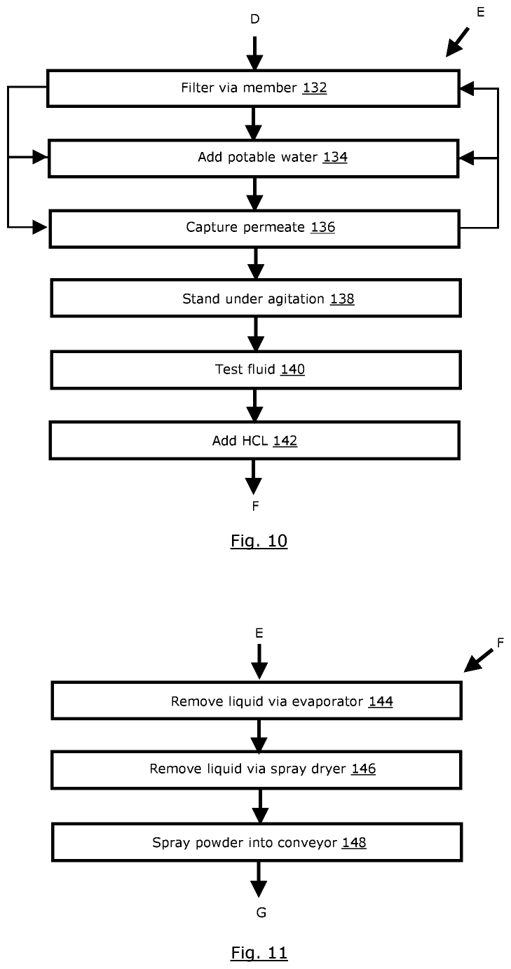

The method 10 of extracting the protein product in accordance with a preferred embodiment of the present invention is depicted in FIGS. 5 to 11 and will be described in relation to FIGS. 1-4. The method generally comprises: an initial milling step A for transforming the bean product into a powder form; a hydrating step B in which the powder is formed into a slurry for further processing; a separation step C in which the slurry is separated in a two stage process into the high protein component; a pasteurisation step D for eliminating pathogens and preparing the extract for an extended shelf life; a filtration stage E whereby the waste water is removed from the slurry for to create a solid extract; a drying stage F where the solid extract is dried to form the powdered extract; and a packaging stage G where the powdered protein extract is blended and packaged for transportation and storage.

The initial milling step A and hydrating step B is depicted in more detail in FIG. 1. In this stage, prior to processing, the raw material is supplied from the farmer in bulk bags where they are stored in a dry and vermin proof environment for pre-inspection and pre-sorting. This may involve each of the bulk bags of Faba Beans being visually inspected for damage and contaminants and sampled to test for the presence of allergens or toxins. Any failed bulk bags of raw material will then be immediately rejected where they may be returned to the farmer or used for stock feed or the like.

Individual bags 11 containing dried faba beans are initially transported to an unloader 12 which lifts and unloads the bag 11 into a hopper 14. In step 100 a sizing screen 15 is provided over the entrance to the hopper 14 such that only beans less than a predetermined size are received into hopper 14 for further processing. The predetermined size may vary depending upon the size of the raw materials being processed but may be in the vicinity of 10-20 mm. Any material larger than this size will be removed from the surface of the screen 15 for disposal or use as stock feed.

A delivery auger 16 is provided to deliver raw material from the hopper 14 into a mill 17 that functions to grind and mill the raw product into a fine powder mix in step 102. The finely milled powder is then delivered to a second hopper where it is caused to pass via gravity through a second sizing screen 19 such that the fine powder is received in a third hopper 20 in step 104. The second sizing screen 19 is much finer than the first sizing screen 15, and may only let material of 300 micron in size to pass therethrough to be received in the third hopper 20. This step ensures that only finely milled raw material in further processed by the system with larger material removed from the second sizing screen for reuse.

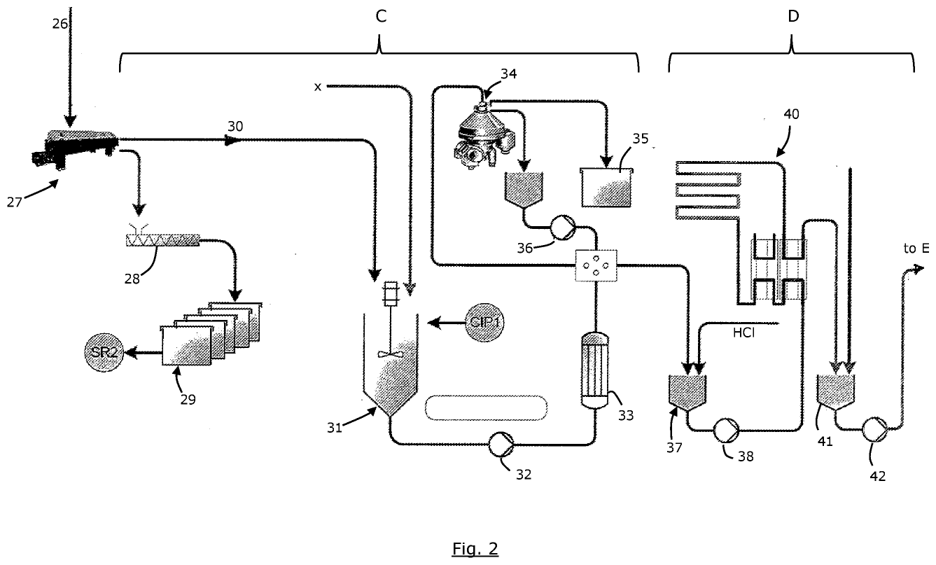

The fine powder present in the hopper 20 is then transported to a mixing hopper 22 by way of a further auger 21. The mixing hopper 22 is associated with a batch mixer 23 which is in fluid communication with a pair of agitated hydrating tanks 24 such that the processed fine powder is able to dispersed into the fluid present in the tanks 24 to create a slurry therewith in step 106. The hydrating tanks 24 are, in step 108, each connected to a fluid supply ‘x’, preferably a potable water supply having water at a temperature of around 45° C., and a fluid supply ‘y’, preferably an alkali mix of around 10% NaOH which is adjusted to a pH of 9.3. The hydrating tanks 24 and the batch mixer 23 is configured to create a mix of around 1:10 ratio of powder to fluid, i.e. 100 Kg of powder to 1000 Litres of fluid in step 110. The system is configured such that the mixture is held in the tanks 24 at around 45° C. for around 60 minutes at a slow agitation speed. To ensure that the mixture is ideal in step 112, the colour of the mixture may be tested and the final pH measurement taken to ensure that the pH is between 9.3-9.5. Upon determination that the mixture is sufficiently mixed to the desired ratio, the resultant slurry work material 26 is delivered to the separation equipment C of FIG. 2 by way of feed pump 25.

The slurry work material 26 is then received by a decanter centrifuge 27 that continually rotates to separate solid materials from the liquid materials in the slurry 26 in step 114. The solids extracted from the decanter centrifuge 27 are typically bean fibre and starch and they are delivered under gravity to an auger 28 where they are received in bins 29 as waste material in step 116. The waste material may contain around only 1-2% of protein and around 60% moisture and can be reused as stock feed, fertiliser or disposed of as required.

The liquid material separated by the decanter centrifuge 27 is generally referred to as milk 30 and is fed to a storage tank 31 where it is held and maintained under agitation prior to further separation in step 118. Potable water x is also provided to the storage tank 31 in step 120 where the fluid is then delivered to a clarifier 34 by way of a feed pump 32. A preheater 33 is provided in the line connecting the storage tank 31 to the clarifier 34 to increase the temperature of the fluid entering the clarifier to around 30° C. in step 122.

The clarifier 34 functions as a settlement tank whereby any solid materials, typically fibre and starch, are removed from the liquid and stored in disposal bins 35 for disposal or use as stock feed in step 124. The remaining fluid is then sent to a further holding tank 37 by way of feed pump 36.

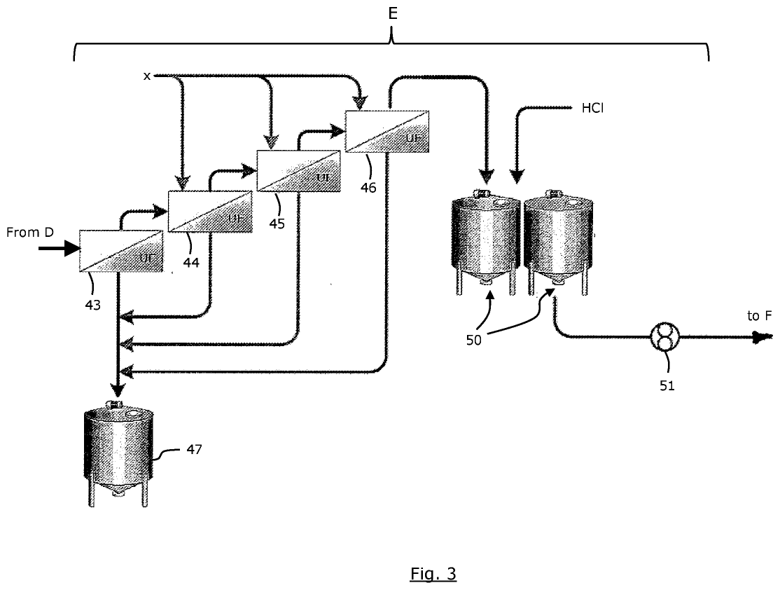

In the holding tank 37 an acid solution (around 5% HCl) is added to the fluid mixture in step 126 to adjust the pH of the fluid to a pH of around 6.8-7.0. The fluid is then pumped by feed pump 38 to a pasteurisation system 40 where the temperature of the fluid is raised to around 72° C. for around 15 seconds in step 128 and then chilled prior to storage in a further holding tank 41

| | Total | | | | |
|---|---|---|---|---|---|
| | soluble | | | | |
| Pulse Type | Sugars % | Sucrose | Raffinose | Stachyose | Verbacose |
| Faba Bean | 3.1-7.1 | 1.4-2.7 | 0.1-0.5 | 0.5-2.4 | 1.6-2.1 |

where 10% NaOH is added to further adjust the pH of the fluid in step 130 to a pH value of around 6.5. The resultant fluid is then sent to the Filtration system E of FIG. 3 by way of pump 42.

Turning to FIG. 3, the fluid is then fed to an ultrafiltration system comprising a plurality of membranes 43-46 each having different permeability ratings to progressively limit the size of the permeate capable of passing therethrough in step 132. Potable water ‘x’ is added in step 134 to the fluid at each stage of filtration and each of the captured permeates that do not pass to the next stage are collected and stored as wastewater permeate in holding tank 47 in step 136. Due to the nature of the process, the wastewater permeate captured and stored in the holding tank 47 can be used as a useful by-product of the process. The wastewater permeate may contain Galactic-oligosaccharides (GOS′), which are classified as prebiotics. Tests taken on the wastewater permeate present in the tank 47 indicate that it comprises sugars having a low molecular weight including sucrose and oligosaccharides, milled flour and protein powder. The breakdown of the concentration of the sugars present in the permeate can be summarised in the table below:

It will be appreciated that there will be variations in the sugar and the carbohydrate content of the waste permeate due to the concentration of sugar in the beans. The amount of wastewater permeate collected in the tank 47 per tonne of beans processed by the system is around 16500 litres (16.5 kl). This wastewater is likely to contain total carbohydrate levels of 57.48-83.6 kg of carbohydrates which will contain 50-74% sugars, the predominate ones being depicted in the chart above. On this basis, it is reasonable to assume that around 50% of the sugars in the waste stream are oligosaccharides, thus providing an important by-product in the overall process.

Therefore, as waste permeate contains sugars which have been removed from the fluid the carbohydrate content, and subsequently the sugar content, of the fluid will be low. In particular, as 50% of the sugars removed are oligosaccharides, the fluid is also low on sugars such as oligosaccharides. Other soluble materials, such as sodium, may also be removed from the fluid via the waste permeate or via other steps in the process.

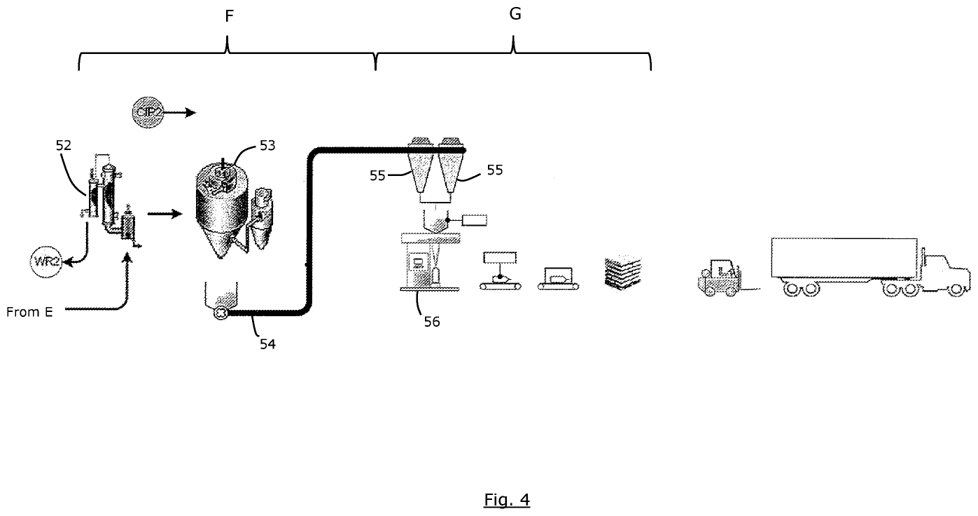

The fluid that passes through the membrane system is then delivered to a storage tanks 50 where it is allowed to stand under agitation for a predetermined period of time in step 138. The fluid present in the tanks 50 may be tested for TSS and pH and where necessary in step 140, 5% HCl may be added in step 142 to achieve a target pH of 6.8. The resultant fluid is then delivered to the Drying system F as depicted in FIG. 4 by way of pump 51.

The drying system F comprises an evaporator 52 which receives the fluid from the storage tanks 50 and removes the liquid therefrom such that the resultant mixture is around 32% total solids in step 144. The mixture is then transported to a Spray Dryer 53 that removes the remainder moisture from the moisture until the mixture becomes a powder with less than 6% moisture content in step 146. The spray dryer then sprays the powdered material into a pneumatic conveyer 54 in step 148 where it is delivered as a high protein powder having greater than 80% protein with less than 6% moisture into powder bins. The applicant considers it will also be possible to remove moisture by the methods described above such that the mixture becomes a powder having greater than 85% protein content or greater than 90% protein content. The powder bins 55 may be directly connected to a bagging machine where the powder can be bagged and labelled and stacked in pellets for transportation from the site as depicted.

It will be appreciated that the process depicted above is very low on water use and is able to recover most of the water used within the process for either direct reuse within the system or for other secondary uses. All solid waste obtained from the process is able to be recovered for use as stock feed or for compost and other purposes.

An analysis performed by OMIC using NATA accredited methodology for the resultant powder is as follows:

Average Nutrition Information per 100 g

| | | |
|---|---|---|
| Energy | 1670 | kL |
| Protein | 83.6 | g |
| Fat - total | 5.4 | g |
| Saturated | 1.2 | g |
| Carbohydrate | 3.8 | g |
| Sugars | 0.9 | g |
| Trans Fat | 0.1 | g |
| Sodium | 290 | mg |
| Potassium | 860 | mg |
| Calcium | 82 | mg |
| Iron | 12 | mg |

It will be appreciated that due to the natural properties of Faba Beans, the resultant powder formed from the above described process is substantially neutral in colour and odour and has minimal flavour/taste. In particular the colour of the resultant powder and/or the powder when in suspension, for example when added as a supplement to water or a beverage, has a pale or light colour which promotes its palatability.

Thus the powder, as well as being high in protein also has high solubility, resulting in a food product that has a variety of potential commercial applications to take advantage of these properties. The resultant powder is also expected by the applicant to have a high solubility of at least 75% which is desirable for those wishing to add the powdered food product to shakes or other beverages. However the applicant anticipates that the solubility of the resultant powder could be at least 85%. As such, the powder can be used, not as a supplement for beverages, but also in protein bars, bakery products, pasta/noodles, extruded snacks, soups, and a variety of other food based applications.

It is also appreciated that as the fluid has a lower content of carbohydrates, sugars or sodium, that the resultant powder will also have a lower content of carbohydrates, sugars, oligosaccharides or sodium. As indicated in the table above showing the average nutrition information, the carbohydrate content can be about 1.4 g per 100 g with sugars as low as 0.9 g per 100 g. Further the sodium content can be about 400 mg per 100 g and the applicant considers that sodium content could be reduced even further by the methods described above to 300 mg per 100 g and preferably to 250 mg per 100 g.

Throughout the specification and claims the word “comprise” and its derivatives are intended to have an inclusive rather than exclusive meaning unless the contrary is expressly stated or the context requires otherwise. That is, the word “comprise” and its derivatives will be taken to indicate the inclusion of not only the listed components, steps or features that it directly references, but also other components, steps or features not specifically listed, unless the contrary is expressly stated or the context requires otherwise.

It will be appreciated by those skilled in the art that many modifications and variations may be made to the methods of the invention described herein without departing from the spirit and scope of the invention.

1. A method of extracting a high protein food product from legumes comprising:
milling a supply of legumes to form a fine powder;
hydrating the fine powder to form a liquid slurry;
separating solids from the liquid slurry to form a milk-like fluid;
pasteurising said milk-like fluid to remove unwanted organisms therefrom;
filtrating said pasteurised milk-like fluid to remove permeates therefrom to form a substantially liquid product; and
removing moisture from the substantially liquid product to generate a high protein food product in the form of a powder.

2. A method according to claim 1, wherein the step of milling the supply of beans comprises screening the beans to remove oversized beans and material from the process.

3. A method according to claim 2, wherein the step of milling comprises passing said screened beans to a mill for grinding into a fine powder.

4. A method according to claim 3, wherein the size of the fine powder is no greater than 300 microns.

5. A method according to claim 1 wherein the step of hydrating the fine powder comprises mixing the fine powder with water at a temperature of between 40-45° C.

6. A method according to claim 5 wherein the step of hydrating the fine powder comprises further mixing the water and the fine powder with 10% NaOH so as to adjust the pH level of the resultant mixture to around pH 9.3.

7. A method according to claim 1, wherein the step of hydrating the fine powder comprises creating the liquid slurry to have a powder to liquid ration of around 1:10.

8. A method according to claim 1, wherein the step of separating solids from the liquid slurry to form a milk-like fluid comprises delivering the liquid slurry to a decanter for an initial period of time.

9. A method according to claim 8, wherein the decanter separates any solids present in the slurry and collects the solids in bins for removal.

10. A method according to claim 8, wherein the method further comprises passing the mixture through a clarifier following decanting.

11. A method according to claim 1, wherein the step of filtrating said pasteurised milk-like fluid to remove permeates therefrom to form a substantially liquid product comprises passing the pasteurised milk-like fluid through an ultrafiltration unit having multiple membranes.

12. A method according to claim 11, wherein the multiple membranes of the ultrafiltration unit have different sized pores to provide staged separation of permeates from the fluid.

13. A method according to claim 1, wherein the amount of moisture removed from the substantially liquid product is at least 94%.

14. A powdered food product produced by claim 1.

15. A powdered food product according to claim 14, wherein the protein content comprises at least 80% on a dry weight basis, preferably at least 85% on a dry weight basis.

16. A powdered food product according to claim 14, having salt content is less than 400 mg/100 g, preferably less than 300 mg/100 g.

17. A powdered food product according to claim 14, having a solubility of at least 75%, preferably at least 85%.

18. A powdered food product according to claim 14, having carbohydrate content of less than 5 g/100 g and sugar content of less than 1.5 g per 100 g.
